(19) United States
(12) Patent Application Publication
(10) Pub. No.: US 2025/0207424 A1
(43) Pub. Date: Jun. 26, 2025

(54) LIFT DEVICE AND VEHICLE PARKING ROBOT INCLUDING THE SAME

(71) Applicant: HL MANDO CORPORATION, Geonggi-do (KR)

(72) Inventors: Min Hye YU, Gyeonggi-do (KR); Seong Ho CHOI, Gyeonggi-do (KR); Joon-Kyu SONG, Gyeonggi-do (KR); Jeong Jae PARK, Gyeonggi-do (KR); Junha SOHN, Gyeonggi-do (KR); Dongseon KIM, Gyeonggi-do (KR); Oseok KWON, Gyeonggi-do (KR); Mingeun PARK, Gyeonggi-do (KR); Byungyong KANG, Gyeonggi-do (KR)

(21) Appl. No.: 18/785,294

(22) Filed: Jul. 26, 2024

(30) Foreign Application Priority Data
Dec. 20, 2023 (KR) 10-2023-0186711

(51) Int. Cl. E04H 6/42; B60S 13/02; B66F 5/02

(52) U.S. Cl. CPC E04H 6/424; B60S 13/02; B66F 5/025

(57) ABSTRACT

A lift device and a vehicle parking robot including the same are disclosed. The lift device according to an aspect of the present disclosure is a lift device coupled to a robot body of a vehicle parking robot that lifts a vehicle having a pair of front wheels and a pair of rear wheels and parks it in a parking lot, and the lift device may include a frame liftably coupled to the robot body; a first driving part for elevating the frame with respect to the robot body; an elastic support part that elastically supports the frame with respect to the robot body when the frame descends with respect to the robot body; and a fork part coupled to the frame and supporting the pair of front wheels or the pair of rear wheels.

### CROSS-REFERENCE TO RELATED APPLICATION

This application claims priority to and the benefit of Korean Patent Application No. 10-2023-0186711, filed on Dec. 20, 2023, the disclosure of which is incorporated herein by reference in its entirety.

### BACKGROUND

### 1. Technical Field

The present disclosure relates to a lift device and a vehicle parking robot including the same.

### 2. Discussion of Related Art

Vehicles are a commonly used means of transportation in modern society, and their use is continuously increasing. This increased use of vehicles causes a shortage of parking spaces to store vehicles when they are not in use.

Accordingly, parking spaces are becoming narrower in order to park vehicles more efficiently, especially in large cities with high population density.

Even if the parking space is designed to be narrower, a minimum space is required for the driver to drive and park or take out the vehicle, so there were limitations in designing the parking space to be smaller.

Furthermore, as parking spaces become narrower, a high degree of skill is inevitably required in the process of parking the vehicle, which ultimately causes accidents, both large and small, when inexperienced drivers park their vehicles.

Recently, vehicle parking robots are being developed that can secure parking spaces and enable dense parking regardless of the driver's skill level.

However, conventional parking robots are vulnerable to loads and shocks generated during the process of lifting and lowering a vehicle. Furthermore, conventional parking robots had a problem where the support force supporting the vehicle momentarily disappeared when driving with the vehicle lifted, causing the vehicle to descend rapidly.

### SUMMARY

The present disclosure is to solve the above problems, and an object of the present disclosure is to provide a lift device configured to alleviate the load and impact generated when lifting and lowering a vehicle.

Another object of the present disclosure is to provide a lift device configured to prevent the vehicle from rapidly descending due to instantaneous loss of support force supporting the vehicle when the parking robot drives while the vehicle is lifted.

The problems of the present disclosure are not limited to those mentioned above, and other problems not mentioned will be clearly understood by those of ordinary skill in the art from the following description.

The objects of the present disclosure are not limited to the above-described objects, and other objects that are not mentioned will be able to be clearly understood by those skilled in the art to which the present disclosure pertains from the following description.

According to an aspect of the present disclosure, provided is a lift device coupled to a robot body of a vehicle parking robot that lifts a vehicle having a pair of front wheels and a pair of rear wheels and parks it in a parking lot, the lift device including: a frame liftably coupled to the robot body; a first driving part for elevating the frame with respect to the robot body; an elastic support part that elastically supports the frame with respect to the robot body when the frame descends with respect to the robot body; and a fork part coupled to the frame and supporting the pair of front wheels or the pair of rear wheels.

In this case, a first-1 guide extending in the up-down direction may be formed in the frame, and a first-2 guide slidably coupled to the first-1 guide may be formed in the robot body.

Meanwhile, the elastic support part may include a bracket fixedly coupled to the robot body; an auxiliary bracket disposed above the bracket, facing the bracket, and fixedly coupled to the frame; and a spring interposed between the bracket and the auxiliary bracket.

Meanwhile, the first driving part may include a first screw extending up and down, an upper end of which is supported so as to rotate idly with respect to the frame; a first driving motor that provides driving force to rotate the first screw; a first power transmission member that transmits the driving force of the first driving motor to the first screw; and a first nut coupled to the first screw, supported by the robot body, and movable along the first screw when the first screw rotates.

In this case, the first nut may be coupled to a bracket that is fixedly coupled to the robot body.

In this case, a hollow open up and down may be formed in the bracket, and the first nut may be inserted into the hollow.

In this case, the elastic support part may include the bracket extending in the longitudinal direction of the vehicle around the first screw; a pair of auxiliary brackets disposed above the bracket, facing one side and the other side in a direction in which the bracket extends, and coupled to the frame; and a pair of springs interposed between one of the pair of auxiliary brackets and one side of the bracket, and between the other one of the pair of auxiliary brackets and the other side of the bracket, respectively.

In this case, the pair of springs may be arranged in parallel with the first screw and spaced apart from the first screw by the same distance.

Meanwhile, the first screw may be located at the center of the length of the frame in the extension direction.

Meanwhile, the fork part may include a pair of forks respectively supporting a front side and rear side of the pair of front wheels or the pair of rear wheels.

In this case, the respective fork may be coupled to the frame to be movable in the longitudinal direction of the vehicle.

In this case, a second-1 guide extending in the longitudinal direction of the vehicle may be formed in the frame, and a second-2 guide slidably coupled to the second-1 guide may be formed in the respective fork.

Meanwhile, the respective fork may include a fork body on which the second-1 guide is formed and slidably coupled to the second-1 guide; and a fork bar extending from the fork body toward the vehicle.

Meanwhile, the lift device may further include a pair of second driving parts for moving the respective fork in the longitudinal direction of the vehicle with respect to the frame, and the second driving part may include a second screw extending in the longitudinal direction of the vehicle and rotatably supported by the frame; a second driving motor that provides driving force to rotate the second screw; a second power transmission member that transmits the driving force of the second driving motor to the first screw; and a second nut coupled to the second screw, supported by the respective fork, and movable along the second screw when the second screw rotates.

According to another aspect of the present disclosure, provided is a vehicle parking robot that lifts a vehicle having a pair of front wheels and a pair of rear wheels and parks it in a parking lot, the vehicle parking robot including: a drivable robot body; and a pair of lift devices coupled to the robot body and lifting the pair of front wheels and the pair of rear wheels, respectively, wherein the respective lift device includes: a frame liftably coupled to the robot body; a first driving part for elevating the frame with respect to the robot body; an elastic support part that elastically supports the frame with respect to the robot body when the frame descends with respect to the robot body; and a fork part coupled to the frame and supporting the pair of front wheels or the pair of rear wheels.

In this case, the robot body may include a robot frame to which the pair of lift devices are coupled; and a driving module coupled to the robot frame to drive the robot frame.

Meanwhile, the first driving part may include a first screw extending up and down, an upper end of which is supported so as to rotate idly with respect to the frame; a first driving motor that provides driving force to rotate the first screw; a first power transmission member that transmits the driving force of the first driving motor to the first screw; and a first nut coupled to the first screw, supported by the robot body, and movable along the first screw when the first screw rotates.

In this case, the first nut may be coupled to a bracket that is fixedly coupled to the robot body.

In this case, a hollow open up and down may be formed in the bracket, and the first nut may be inserted into the hollow.

In this case, the elastic support part may include the bracket extending in the longitudinal direction of the vehicle around the first screw; a pair of auxiliary brackets disposed above the bracket, facing one side and the other side in a direction in which the bracket extends, and coupled to the frame; and a pair of springs interposed between one of the pair of auxiliary brackets and one side of the bracket, and between the other one of the pair of auxiliary brackets and the other side of the bracket, respectively.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a view of a vehicle parking robot viewed from above according to an embodiment of the present disclosure.

FIG. 2 is a view of a vehicle parking robot viewed from below according to an embodiment of the present disclosure.

FIGS. 3 and 4 are views showing a use case of a vehicle parking robot according to an embodiment of the present disclosure.

FIG. 5 is a view of a lift device viewed from one direction according to an embodiment of the present disclosure.

FIG. 6 is a view of a lift device viewed from another direction according to an embodiment of the present disclosure.

FIG. 7 is a view showing a part of cross-section AA in FIG. 6.

FIG. 8 is a view showing a part of a lift device according to an embodiment of the present disclosure.

FIG. 9 is an exploded perspective view for describing a partial configuration of part B in FIG. 8.

FIG. 10 is an exploded perspective view for describing a partial configuration of part C in FIG. 8.

### DETAILED DESCRIPTION OF EXEMPLARY EMBODIMENTS

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used in the specification and the claims are not limitedly construed as their ordinary or dictionary meanings, and should be construed as meaning and concept consistent with the technical spirit of the present disclosure in accordance with the principle that the inventors can define terms and concepts in order to best describe their invention.

In the specification, it should be understood that the terms such as “comprise” or “have” are intended to specify the presence of features, numbers, steps, operations, components, parts, or combinations thereof described in the specification and do not preclude the possibility of the presence or addition of one or more other features, numbers, steps, operations, components, parts, or combinations thereof.

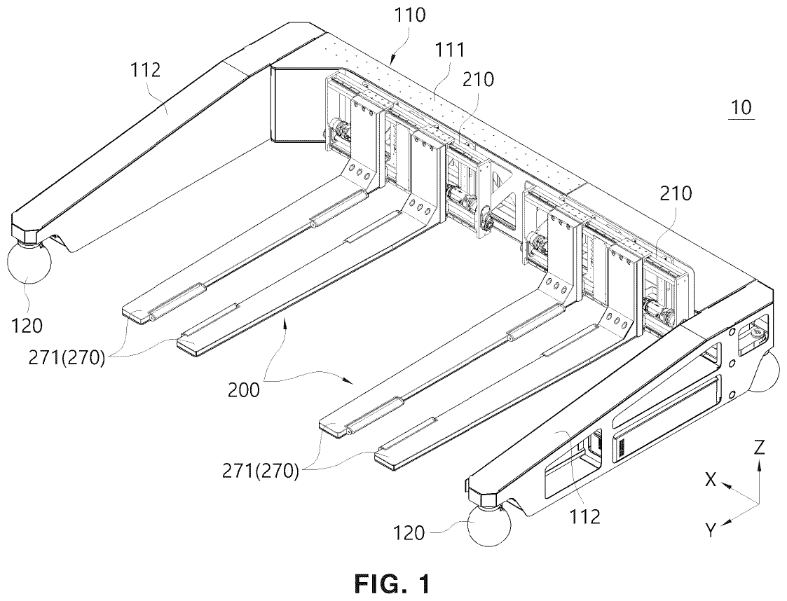

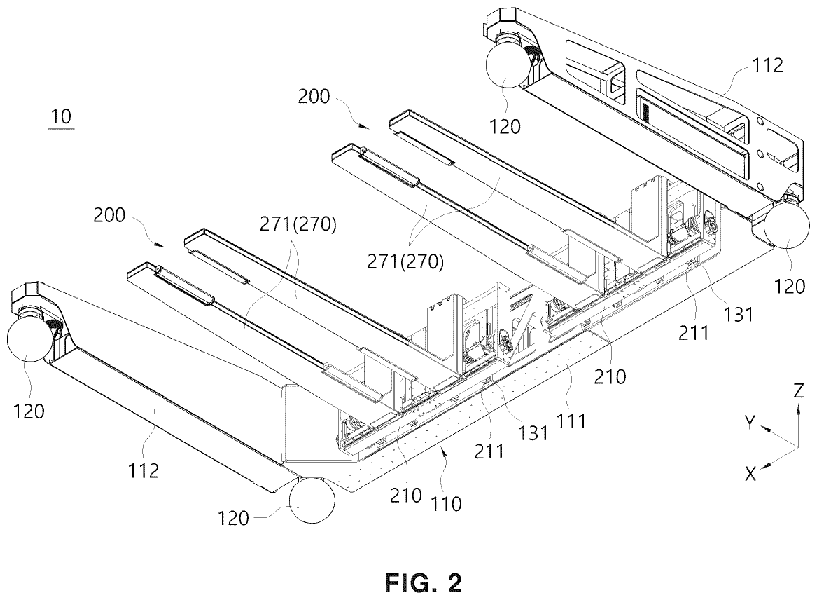

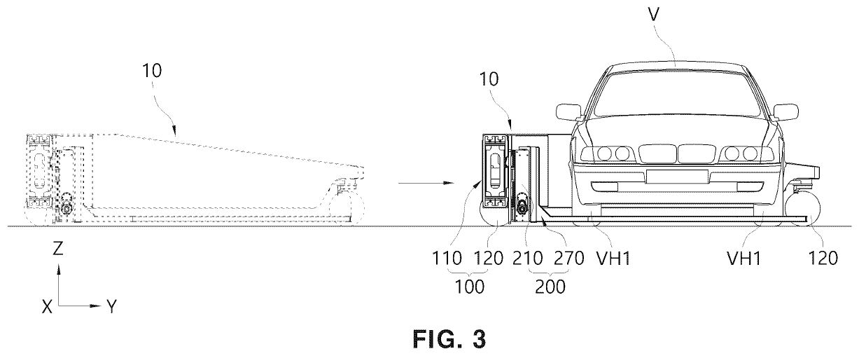

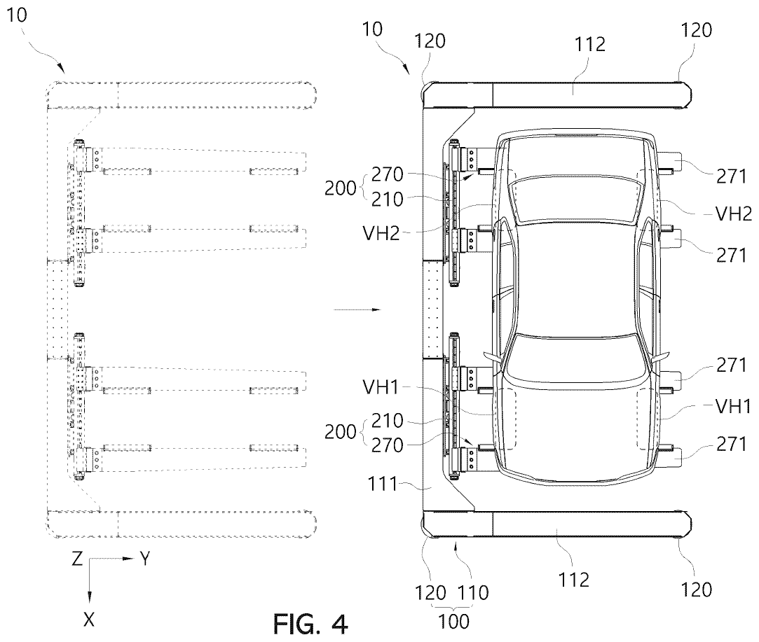

FIG. 1 is a view of a vehicle parking robot viewed from above according to an embodiment of the present disclosure, FIG. 2 is a view of a vehicle parking robot viewed from below according to an embodiment of the present disclosure, and FIGS. 3 and 4 are views showing a use case of a vehicle parking robot according to an embodiment of the present disclosure.

Referring to FIGS. 1 to 4, the vehicle parking robot 10 according to the present embodiment is configured to include a drivable robot body 100 and a pair of lift devices 200, and lifts a vehicle V having a pair of front wheels VH1 and a pair of rear wheels VH2 to park the vehicle in a parking lot.

The robot body 100 is capable of driving.

The robot body 100 may include a robot frame 110, which is a structure, and a driving module 120 for driving the robot frame 110.

The robot frame 110 may be constructed by combining bars or plates.

The robot frame 110 may have a U-shape with one side open.

In other words, the robot frame 110 partially extends in the longitudinal direction of the vehicle V, for example, in the X-axis direction in FIGS. 3 and 4, and partially extends in the width direction of the vehicle V, for example, in the Y-axis direction in FIGS. 3 and 4. The portions 112 extending in the width direction of the vehicle V of the robot frame 110 are disposed at both ends of the portion 111 extending in the longitudinal direction of the vehicle V, respectively.

The vehicle V may be introduced into a concave portion of the robot frame 110 through one open side of the robot frame 110. In this case, the vehicle V does not move to the robot frame 110, but the robot frame 110 moves to the stationary vehicle V.

The driving module 120 is installed in the robot frame 110. The driving module 120 is a module capable of independently driving and steering, and a plurality of driving modules may be installed in the robot frame 110. In FIGS. 1 and 2, four driving modules 120 are installed in the robot frame 110. The four driving modules 120 may be installed at four corner portions of the robot frame 110.

The driving module 120 is operated by electricity. The driving module 120 capable of independently driving and steering may be a corner module including an in-wheel driving module and a steering module.

The robot body 100 may further include a battery (not shown) for driving the driving module 120 and a computer device (not shown) for controlling the driving module 120 and controlling and operating various devices for operating the vehicle parking robot 10.

A pair of lift devices 200 are installed in the robot body 100. The pair of lift devices 200 lifts a pair of front wheels VH1 and a pair of rear wheels VH2 provided in the vehicle V, respectively.

As shown in FIGS. 3 and 4, the vehicle parking robot 10 operates in such a manner that when the pair of lift devices 200 lift the vehicle V while supporting the pair of front wheels VH1 and the pair of rear wheels VH2, respectively, the robot body 100 moves the vehicle V to a parking place, and the pair of lift devices 200 unload the vehicle V to the parking place.

According to the present embodiment, a pair of lift devices 200 are coupled to the robot body 100.

The pair of lift devices 200 are spaced apart in the longitudinal direction of the vehicle V, for example, in the X-axis direction in the drawing and installed in the robot body 100.

The configuration and operation mechanism of the pair of lift devices 200 differ only in the position installed in the robot body 100 or in the object of lifting of the pair of front wheels VH1 and the pair of rear wheels VH2 but have the same configuration and operation mechanism.

Furthermore, the pair of front wheels VH1 and the pair of rear wheels VH2 corresponding to each lift device 200 may vary depending on the relative positions of the vehicle parking robot 10 and the vehicle V. For example, in FIGS. 3 and 4, the front of the vehicle V is in the +X direction, and in the drawing, the lift device 200 located on the right side of the pair of lift devices 200 lifts the front wheels VH1. However, if the front of the vehicle is in the −X-axis direction when viewed from FIGS. 3 and 4, the lift device 200 located on the left side lifts the front wheels when viewed from the drawing.

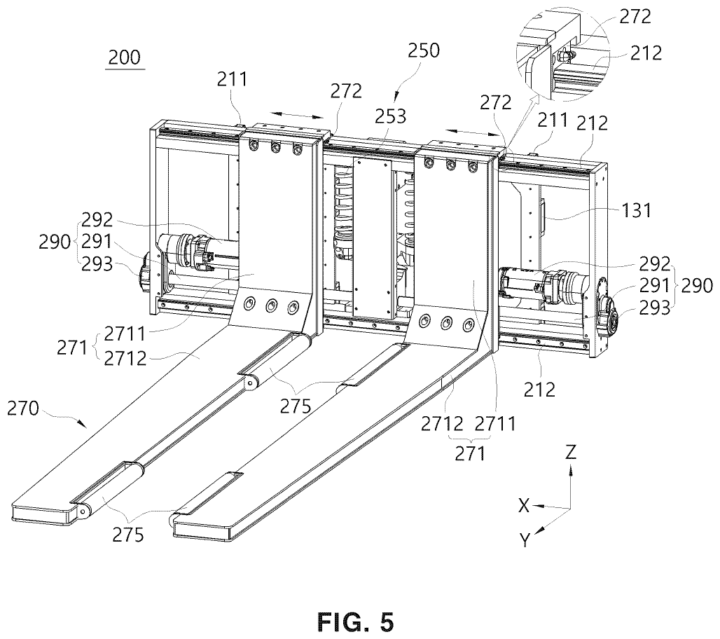

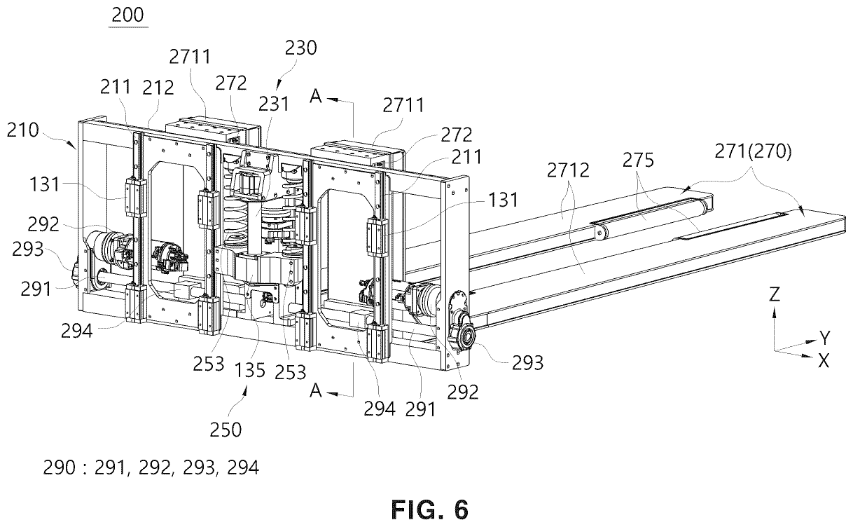

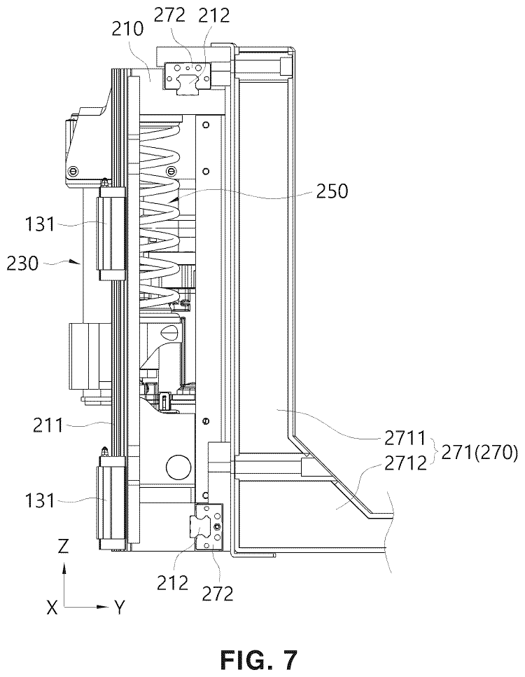

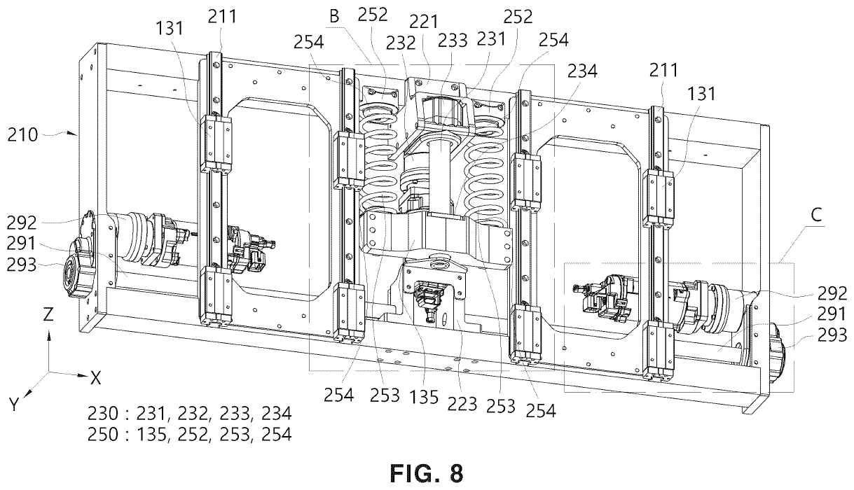

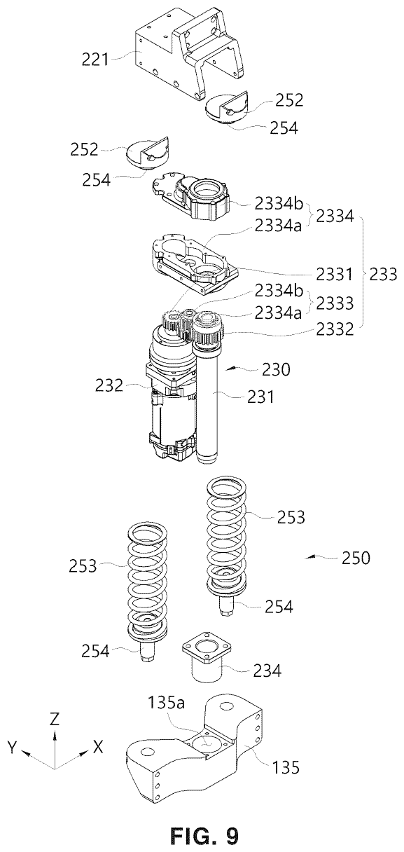

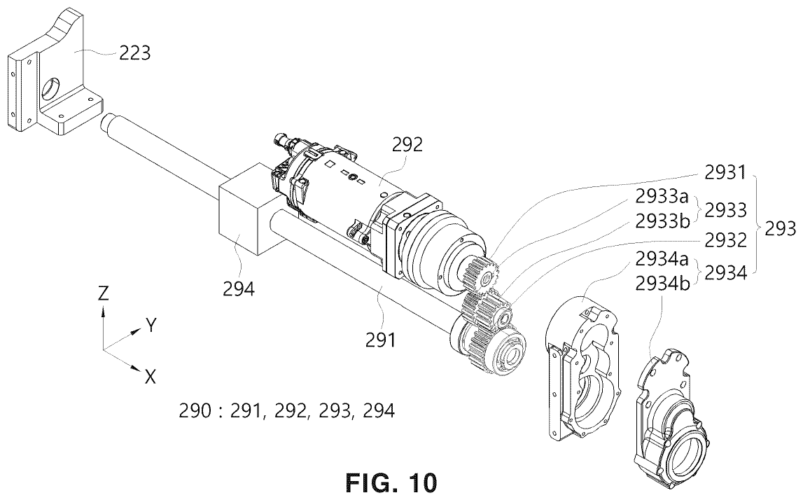

FIG. 5 is a view of a lift device viewed from one direction according to an embodiment of the present disclosure, FIG. 6 is a view of a lift device viewed from another direction according to an embodiment of the present disclosure, FIG. 7 is a view showing a part of cross-section AA in FIG. 6, FIG. 8 is a view showing a part of a lift device according to an embodiment of the present disclosure, FIG. 9 is an exploded perspective view for describing a partial configuration of part B in FIG. 8, and FIG. 10 is an exploded perspective view for describing a partial configuration of part C in FIG. 8.

Hereinafter, the lift device 200 will be described with reference to FIGS. 4 to 10. In describing the lift device 200, an object lifted by the lift device 200 is referred to as a pair of target wheels. In this case, the pair of target wheels is one of a pair of front wheels VH1 and a pair of rear wheels VH2.

The lift device 200 according to the present embodiment may include a frame 210, a first driving part 230, an elastic support part 250, and a fork part 270.

The frame 210 is a structure that supports the fork part 270, which will be described later.

The frame 210 may be constructed by combining bars or plates. The frame 210 extends in the longitudinal direction of the vehicle V. The frame 210 may be made in an overall rectangular parallelepiped shape, but is not limited thereto.

The frame 210 is coupled to the robot body 100 to be capable of being lifted up and down.

For example, a first-1 guide 211 extending in the up-down direction, for example, in the Z-axis direction in the drawing, may be formed in the frame 210, and a first-2 guide 131 slidably coupled to the first-1 guide 211 may be formed in the robot body 100. For reference, the first-2 guide 131 formed in the robot body 100 is shown in FIG. 2.

For example, the first-1 guide 211 may have a rail shape protruding from the frame 210 and extending in the up-down direction, and the first-2 guide 131 may have a block shape in which a sliding groove portion is formed into which the first-1 guide 211 is inserted and slides.

The first-2 guides 131 may be provided in plural numbers and distributed in a distributed manner on the robot body 100.

Alternatively, although not shown, the first-1 guide may have a block shape with a rail groove portion formed extending in the up-down direction. In this case, the first-2 guide may have a rail shape that is inserted into the rail groove portion of the first-1 guide and slides.

The first driving part 230 may include a first screw 231, a first driving motor 232, a first power transmission member 233, and a first nut 234.

The first screw 231 extends in the up-down direction, for example, in the Z-axis direction in the drawing, and its upper end is supported so as to rotate idly with respect to the frame 210. The upper end of the first screw 231 is rotatably supported by a first gearbox 2334, which will be described later, and the first gearbox 2334 is supported by the frame 210.

The first driving motor 232 provides driving force to rotate the first screw 231. The first driving motor 232 is supported by the frame 210.

The motor shaft of the first driving motor 232 may extend in the up-down direction parallel to the extension direction of the first screw 231.

The first power transmission member 233 transmits the driving force of the first driving motor 232 to the first screw 231.

For example, the first power transmission member 233 may include a first driving gear 2331 coupled to the motor shaft of the first driving motor 232, a first driven gear 2332 coupled to the upper end of the first screw 231, and a first intermediate gear 2333 interposed between the first driving gear 2331 and the first driven gear 2332.

The first intermediate gear 2333 may have a two-stage gear structure having different sizes vertically. A first-1 intermediate gear 2333a of the first intermediate gear 2333 is engaged with the first driving gear 2331, and a first-2 intermediate gear 2333b of the first intermediate gear 2333 is engaged with the first driven gear 2332. In this case, the first-2 intermediate gear 2333b may be smaller than the first-1 intermediate gear 2333a, but it is not limited thereto.

The first driving gear 2331, the first intermediate gear 2333, and the first driven gear 2332 may be rotatably supported by the first gearbox 2334. The first gearbox 2334 rotatably supports the first screw 231. The first gearbox 2334 may include a first-1 gearbox 2334a and a first-2 gearbox 2334b that are coupled to each other.

And the first driving motor 232 may be fixedly coupled to the first gearbox 2334, and the first screw 231 may be rotatably supported by the first gearbox 2334.

The first gearbox 2334 may be fixed to the frame 210 by a first fixing bracket 221.

The first nut 234 is coupled to the first screw 231 and moves along the first screw 231 when the first screw 231 rotates. The first nut 234 is supported by the robot body 100. In this case, the first nut 234 may be supported by being coupled to a bracket 135 described later that is fixedly coupled to the robot body 100, or directly coupled to the robot body 100.

In this first driving part 230, when the first driving motor 232 rotates, the first power transmission member 233 transmits rotational driving force of the first driving motor 232 to the first screw 231.

When the first screw 231 rotates, the first screw 231 can be raised and lowered along the first nut 234, which is supported and fixed in position by the robot body 100. In this case, the frame 210 supporting the first screw 231 may be raised and lowered relative to the robot body 100.

The frame 210 may rise or fall relative to the robot body 100 depending on the rotation direction of the first screw 231.

The first screw 231 may be disposed in the extension direction of the frame 210, for example, at the center of the length in the X-axis direction in the drawing. In this case, balance can be easily maintained when the frame 210 is raised and lowered relative to the robot body 100 by the first screw 231.

In the present embodiment, the first nut 234 may be coupled to the bracket 135 fixedly coupled to the robot body 100.

A hollow 135a into which the first nut 234 is inserted may be formed in the bracket 135. The hollow 135a is formed by penetrating the bracket 135 upward and downward.

A flange for bolt-coupling to the bracket 135 may be formed in the first nut 234 inserted into the hollow 135a of the bracket 135.

The first nut 234 coupled to the bracket 135 fixedly coupled to the robot body 100 may be supported by the robot body 100 and fixed in position when the first screw 231 rotates, and the first screw 231 may be raised and lowered along the first nut 234.

The lower end of the first screw 231 descending along the first nut 234 may protrude downward through the lower opening of the hollow 135a formed in the bracket 135.

The elastic support part 250 elastically supports the frame 210 with respect to the robot body 100 when the frame 210 moves downward with respect to the robot body 100.

The elastic support part 250 may include a bracket 135 fixedly coupled to the robot body 100, an auxiliary bracket 252, and a spring 253. The bracket 135 may form part of the elastic support part 250 and at the same time serve as a member for supporting the first nut 234 as described above.

The auxiliary bracket 252 may be disposed above the bracket 135 and facing the bracket 135. The auxiliary bracket 252 may be fixedly coupled to the frame 210. In this case, the auxiliary bracket 252 may be bolted to the frame 210.

The spring 253 may be interposed between the bracket 135 and the auxiliary bracket 252. The spring 253 may be a coil spring 253, but is not limited thereto.

The lower end and upper end of the spring 253 may be fixedly coupled to the bracket 135 and the auxiliary bracket 252 by bolts 254, respectively, to prevent the spring 253 from being separated between the bracket 135 and the auxiliary bracket 252.

In the present embodiment, the bracket 135 may extend in the longitudinal direction of the vehicle V with respect to the first screw 231, for example, in the X-axis direction when viewed in the drawing. And a pair of auxiliary brackets 252 and a pair of springs 253 may be provided. The pair of auxiliary brackets 252 may be disposed above the bracket 135 to face one side and the other side in the extension direction of the bracket 135, for example, in the X-axis direction in the drawing, respectively.

The pair of springs 253 may be interposed between one of the pair of auxiliary brackets 252 and one side of the bracket 135, and between the other one of the pair of auxiliary brackets 252 and the other side of the bracket 135, respectively.

The spring 253 may be compressed when the first screw 231 descends with respect to the first nut 234. That is, when the frame 210 descends with respect to the robot body 100, the spring 253 is gradually compressed. The elastic force generated from the compressed spring 253 may alleviate a load or impact generated when the frame 210 descends with respect to the robot body 100.

In particular, when the frame 210 descends while a pair of target wheels are supported by the fork part 270 to be described later, an excessive load or impact due to the weight of the vehicle V may be transmitted to the first driving part 230 or the like. In this case, the elastic support part 250 configured as described above may alleviate excessive load or impact transmitted to the first driving part 230 when the frame 210 descends with respect to the robot body 100.

On the other hand, if a reason such as the first driving motor 232 does not operate while the frame 210 is raised with respect to the robot body 100 by the first driving part 230, there is a possibility that the first screw 231 may be released from the first nut 234 and the frame 210 may descend with respect to the robot body 100.

The elastic support part 250 according to the present embodiment elastically supports the frame 210 with respect to the robot body 100, thereby preventing the first screw 231 from being released from the first nut 234 and preventing the frame 210 from suddenly descending.

The pair of springs 253 may be disposed in parallel with the first screw 231. And the pair of springs 253 may be disposed to be spaced apart from the first screw 231 by the same distance.

In this case, the elastic force provided by the pair of springs 253 may be provided between the frame 210 and the robot body 100 in a balanced manner around the first screw 231.

The fork part 270 supports a pair of target wheels.

The fork part 270 may include a pair of forks 271.

The pair of forks 271 are coupled to the frame 210. The pair of forks 271 support the front side and rear side of the pair of target wheels, respectively.

The pair of forks 271 are coupled to the frame 210 to be movable in the longitudinal direction of the vehicle V, respectively.

In this case, an interval between the pair of forks 271 may be adjusted, and the interval between the pair of forks 271 may be adjusted according to the size of the pair of target wheels.

A second-1 guide 212 extending in the longitudinal direction of the vehicle V may be formed in the frame 210, and a second-2 guide 272 slidably coupled to the second-1 guide 212 may be formed in the pair of forks 271, respectively.

For example, the second-1 guide 212 may have a rail shape protruding from the frame 210 and extending in the longitudinal direction of the vehicle V, and the second-2 guide 272 may have a block shape in which a sliding groove portion is formed into which the second-1 guide 212 is inserted and slides.

Alternatively, although not shown, the second-1 guide may have a block shape with a rail groove portion formed extending in the longitudinal direction of the vehicle V. In this case, the second-2 guide may have a rail shape that is inserted into the rail groove portion of the second-1 guide and slides.

For example, the second-1 guide 212 may be formed on the upper side of the frame 210 and the side of the frame 210 facing the vehicle V. In this case, a second-2 guide 272 corresponding to the second-1 guide 212 may be formed on an upper portion of the fork 271 and a side portion facing the frame 210 of the fork 271.

The pair of forks 271 have the same structure and operation mechanism.

The fork 271 may include a fork body 2711 and a fork bar 2712.

The fork body 2711 is slidably coupled to the frame 210 in the longitudinal direction of the vehicle V. A second-2 guide 272 to be slidably coupled along the second-1 guide 212 formed in the frame 210 is formed in the fork body 2711.

The fork bar 2712 extends from the fork body 2711 in a direction away from frame 210, for example, in the +Y axis direction in the drawing. In other words, the fork bar 2712 extends from the fork body 2711 in a direction toward the vehicle V.

A pair of support rollers 275 may be formed on the fork bar 2712 to directly contact and support the front or rear sides of a pair of target wheels. The support roller 275 extends in the extension direction of the fork bar 2712.

The pair of support rollers 275 may be spaced apart from each other in the extension direction of the fork bar 2712. In this case, an interval between the pair of support rollers 275 may be the same as a distance between wheels of the pair of target wheels.

The support roller 275 may rotate around a rotation shaft extending in the extension direction of the fork bar 2712. In other words, the support roller 275 may rotate around a rotation shaft parallel to the rotation shaft of the pair of target wheels.

The pair of fork bars 2712 may enter into the width direction of the vehicle V and be disposed in front and rear of the pair of target wheels.

In this case, the fork bar 2712 located in front of the pair of target wheels gradually moves backward to support the front side of the pair of target wheels, and the fork bar 2712 located in rear of the pair of target wheels gradually moves forward to support the rear side of the pair of target wheels.

At this time, the support rollers 275 formed in the fork bar 2712 located in front of the pair of target wheels may rotate when the fork bar 2712 moves backward and contacts the front side of the pair of target wheels.

In this case, the fork bar 2712 may move deeper to the rear, thereby more easily and stably supporting the front side of the pair of target wheels.

And the support rollers 275 formed in the fork bar 2712 located in rear of the pair of target wheels may rotate when the fork bar 2712 moves forward and contacts the rear side of the pair of target wheels.

In this case, the fork bar 2712 may move deeper to the front, thereby more easily and stably supporting the rear side of the pair of target wheels.

The lift device 200 may further include a pair of second driving parts 290 for moving the pair of forks 271 in the longitudinal direction of the vehicle V with respect to the frame 210.

The pair of second driving parts 290 have the same structure and operation mechanism, although they are slightly different in position or arrangement.

The second driving part 290 may include a second screw 291, a second driving motor 292, a second power transmission member 293, and a second nut 294.

The second screw 291 extends in the longitudinal direction of the vehicle V and is rotatably supported by the frame 210. In this case, one end of the second screw 291 may be rotatably supported by a sidewall of the frame 210, and the other end of the second screw 291 may be rotatably supported by the support bracket 223 formed in the frame 210. In this case, one end of the second screw 291 may be supported by the frame 210 via a second gearbox 2934, which will be described later.

The second driving motor 292 provides driving force to rotate the second screw 291. The second driving motor 292 is supported by the frame 210.

The motor shaft of the second driving motor 292 may extend parallel to the extension direction of the second screw 291.

The second power transmission member 293 transmits the driving force of the second driving motor 292 to the second screw 291. For example, the second power transmission member 293 may include a second driving gear 2931 coupled to the motor shaft of the second driving motor 292, a second driven gear 2932 coupled to one end of the second screw 291, and a second intermediate gear 2933 interposed between the second driving gear 2931 and the second driven gear 2932.

The second intermediate gear 2933 may have a two-stage gear structure having different sizes in the longitudinal direction of the vehicle V.

A second-1 intermediate gear 2933a of the second intermediate gear 2933 is engaged with the second driving gear 2931, and a second-2 intermediate gear 2933b of the second intermediate gear 2933 is engaged with the second driven gear 2932. In this case, the second-2 intermediate gear 2933b of the second intermediate gear 2933 may be smaller than the second-1 intermediate gear 2933a, but it is not limited thereto.

The second driving gear 2931, the second intermediate gear 2933, and the second driven gear 2932 may be rotatably supported by the second gearbox 2934. The second screw 291 is rotatably supported by the second gearbox 2934. The second gearbox 2934 may include a second-1 gearbox 2934a and a second-2 gearbox 2934b that are coupled to each other.

And the second driving motor 292 may be fixedly coupled to the second gearbox 2934, and the second screw 291 may be rotatably supported by the second gearbox 2934.

The second gearbox 2934 may be fixed to the frame 210.

The second nut 294 is coupled to the second screw 291 and moves along the second screw 291 when the second screw 291 rotates. The second nut 294 is coupled to the fork 271.

In this second driving part 290, when the second driving motor 292 rotates, the second power transmission member 293 transmits rotational driving force of the second driving motor 292 to the second screw 291. When the second screw 291 rotates, the second nut 294 coupled to the fork 271 may move along the second screw 291. In this case, the fork 271 coupled to the second nut 294 may move in the longitudinal direction of the vehicle V.

As discussed above, the lift device 200 according to the present embodiment includes the elastic support part 250 that elastically supports the frame 210 with respect to the robot body 100 when the frame 210 descends with respect to the robot body 100, thereby mitigating a load or shock generated when the frame 210 descends with respect to the robot body 100 and reducing a load or shock transmitted to the first driving part 230 for elevating the frame 210 with respect to the robot body 100.

Furthermore, in the lift device 200 according to the present embodiment, the elastic support part 250 elastically supports the frame 210 with respect to the robot body 100, thereby capable of preventing the first screw 231 from being released from the first nut 234 and preventing the frame 210 from suddenly descending.

The lift device 200 as described above may be modularized and produced and sold separately.

According to the above configuration, the lift device according to an aspect of the present disclosure includes the elastic support part that elastically supports the frame with respect to the robot body when the frame descends with respect to the robot body, thereby mitigating a load or shock generated when the frame descends with respect to the robot body and reducing a load or shock transmitted to the first driving part for elevating the frame with respect to the robot body.

Furthermore, in the lift device according to the present embodiment, the elastic support part elastically supports the frame with respect to the robot body, thereby capable of preventing the first screw from being released from the first nut, which is a component of the first driving part, and preventing the frame from suddenly descending.

It should be understood that the effects of the present disclosure are not limited to the above-described effects, and include all effects inferable from a configuration of the invention described in detailed descriptions or claims of the present disclosure.

Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

What is claimed is:

1. A lift device coupled to a robot body of a vehicle parking robot that lifts a vehicle having a pair of front wheels and a pair of rear wheels and parks it in a parking lot, the lift device comprising:
a frame liftably coupled to the robot body;
a first driving part for elevating the frame with respect to the robot body;
an elastic support part that elastically supports the frame with respect to the robot body when the frame descends with respect to the robot body; and
a fork part coupled to the frame and supporting the pair of front wheels or the pair of rear wheels.

2. The lift device of claim 1,
wherein a first-1 guide extending in the up-down direction is formed in the frame, and
a first-2 guide slidably coupled to the first-1 guide is formed in the robot body.

3. The lift device of claim 1,
wherein the elastic support part comprises:
a bracket fixedly coupled to the robot body;
an auxiliary bracket disposed above the bracket, facing the bracket, and fixedly coupled to the frame; and
a spring interposed between the bracket and the auxiliary bracket.

4. The lift device of claim 1,
wherein the first driving part comprises:
a first screw extending up and down, an upper end of which is supported so as to rotate idly with respect to the frame;
a first driving motor that provides driving force to rotate the first screw;
a first power transmission member that transmits the driving force of the first driving motor to the first screw; and
a first nut coupled to the first screw, supported by the robot body, and movable along the first screw when the first screw rotates.

5. The lift device of claim 4, wherein the first nut is coupled to a bracket that is fixedly coupled to the robot body.

6. The lift device of claim 5, wherein a hollow open up and down is formed in the bracket, and the first nut is inserted into the hollow.

7. The lift device of claim 6,
wherein the elastic support part comprises:
the bracket extending in the longitudinal direction of the vehicle around the first screw;
a pair of auxiliary brackets disposed above the bracket, facing one side and the other side in a direction in which the bracket extends, and coupled to the frame; and
a pair of springs interposed between one of the pair of auxiliary brackets and one side of the bracket, and between the other one of the pair of auxiliary brackets and the other side of the bracket, respectively.

8. The lift device of claim 7, wherein the pair of springs are arranged in parallel with the first screw and spaced apart from the first screw by the same distance.

9. The lift device of claim 4, wherein the first screw is located at the center of the length of the frame in the extension direction.

10. The lift device of claim 1,
wherein the fork part comprises:
a pair of forks respectively supporting a front side and rear side of the pair of front wheels or the pair of rear wheels.

11. The lift device of claim 10, wherein the respective fork is coupled to the frame to be movable in the longitudinal direction of the vehicle.

12. The lift device of claim 11,
wherein a second-1 guide extending in the longitudinal direction of the vehicle is formed in the frame, and
a second-2 guide slidably coupled to the second-1 guide is formed in the respective fork.

13. The lift device of claim 11,
wherein the respective fork comprises:
a fork body on which the second-1 guide is formed and slidably coupled to the second-1 guide; and
a fork bar extending from the fork body toward the vehicle.

14. The lift device of claim 11,
further comprising a pair of second driving parts for moving the respective fork in the longitudinal direction of the vehicle with respect to the frame,
wherein the second driving part comprises:
a second screw extending in the longitudinal direction of the vehicle and rotatably supported by the frame;
a second driving motor that provides driving force to rotate the second screw;
a second power transmission member that transmits the driving force of the second driving motor to the first screw; and
a second nut coupled to the second screw, supported by the respective fork, and movable along the second screw when the second screw rotates.

15. A vehicle parking robot that lifts a vehicle having a pair of front wheels and a pair of rear wheels and parks it in a parking lot, the vehicle parking robot comprising:
a drivable robot body; and
a pair of lift devices coupled to the robot body and lifting the pair of front wheels and the pair of rear wheels, respectively,
wherein the respective lift device comprises:
a frame liftably coupled to the robot body;
a first driving part for elevating the frame with respect to the robot body;
an elastic support part that elastically supports the frame with respect to the robot body when the frame descends with respect to the robot body; and
a fork part coupled to the frame and supporting the pair of front wheels or the pair of rear wheels.

16. The vehicle parking robot of claim 15,
wherein the robot body comprises:
a robot frame to which the pair of lift devices are coupled; and
a driving module coupled to the robot frame to drive the robot frame.

17. The vehicle parking robot of claim 15,
wherein the first driving part comprises:
a first screw extending up and down, an upper end of which is supported so as to rotate idly with respect to the frame;
a first driving motor that provides driving force to rotate the first screw;
a first power transmission member that transmits the driving force of the first driving motor to the first screw; and
a first nut coupled to the first screw, supported by the robot body, and movable along the first screw when the first screw rotates.

18. The vehicle parking robot of claim 17, wherein the first nut is coupled to a bracket that is fixedly coupled to the robot body.

19. The vehicle parking robot of claim 18, wherein a hollow open up and down is formed in the bracket, and the first nut is inserted into the hollow.

20. The vehicle parking robot of claim 19,
wherein the elastic support part comprises:
the bracket extending in the longitudinal direction of the vehicle around the first screw;
a pair of auxiliary brackets disposed above the bracket, facing one side and the other side in a direction in which the bracket extends, and coupled to the frame; and
a pair of springs interposed between one of the pair of auxiliary brackets and one side of the bracket, and between the other one of the pair of auxiliary brackets and the other side of the bracket, respectively.
